(19) United States
(12) Patent Application Publication
(10) Pub. No.: US 2006/0088757 A1
(43) Pub. Date: Apr. 27, 2006

(54) Fuel cell apparatus with double-sided flow field board

(76) Inventors: Hsi Ming Shu, Taipei (TW); Yean Der Kuan, Taipei (TW); Feng Yi Deng, Taipei (TW); Tsang Ming Chang, Taipei (TW); Weili Huang, Taipei (TW)

Correspondence Address: G. LINK Co., LTD, 3550 Bell Road, Minooka, IL, 60447, US

(21) Appl. No.: 11/102,202

(22) Filed: Apr. 11, 2005

(30) Foreign Application Priority Data
Oct. 26, 2004 (TW) 093217017

(51) Int. Cl. H01M 8/02

(52) U.S. Cl. 429/39; 429/38

(57) ABSTRACT

The present invention is related to a fuel cell apparatus with a double-sided flow field board which comprises a double-sided flow field board and two fuel cell boards. The double-sided flow field board comprises a board body and the flow field structure respectively placed on both sides of the board body. The two fuel cell boards are respectively covered and pasted on both sides of the board body.

### FIELD OF THE INVENTION

The present invention is related to a fuel cell, especially to a fuel cell apparatus with a double-sided flow field board.

### BACKGROUND OF THE INVENTION

Since the conventional fuel cell apparatus places the flow field structure like the channel on the single side of the flow field board, the membrane electrode assembly of the fuel cell apparatus is chosen only to be pasted on the single side. If such a conventional structure were used in the fuel cell apparatus with a planar and large area, the area of the flow field board has to at least approach the area of the fuel cell apparatus so as to make each membrane electrode assembly of the fuel cell acquire fuel supply. Therefore, the conventional fuel cell apparatus is obviously difficult to be implemented for a miniaturized fuel cell apparatus.

The present invention is based on the disadvantages of conventional fuel cells and for improvement to invent a fuel cell apparatus with a double-sided flow field board.

### SUMMARY OF THE INVENTION

The first object of the present invention is to provide a fuel cell apparatus with a double-sided flow field board to enormously reduce the whole volume of the fuel cell and multiply the electrical power.

To achieve the above objects, the present invention provides a fuel cell apparatus with a double-sided flow field board comprising: a double-sided flow field board, which includes a board body and the flow field structure respectively placed on both sides of the board body; two fuel cell boards, which are respectively covered and pasted on both sides of the flow field board body.

### BRIEF DESCRIPTION OF THE DRAWINGS

The above objects and advantages of the present invention will become more apparent with reference to the appended drawings wherein:

FIG. 1 shows the elevational view of the fuel cell apparatus with a double-sided flow field board of the present invention;

FIG. 2 shows the decomposition figure of the FIG. 1 of the present invention;

FIG. 3 shows the sided cross sectional figure of the FIG. 1 of the present invention;

FIG. 4 shows the top view of the top side of the present invention's double-sided flow field board; and

FIG. 5 shows the bottom view of the bottom side of the double-sided flow field board in FIG. 4.

### DETAILED DESCRIPTION OF THE INVENTION

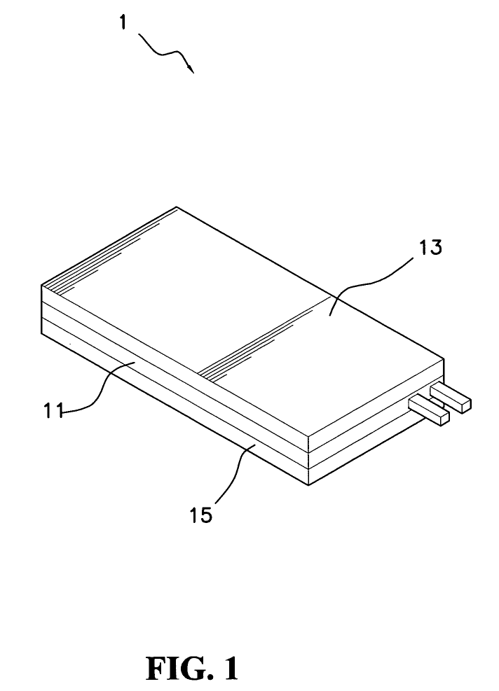

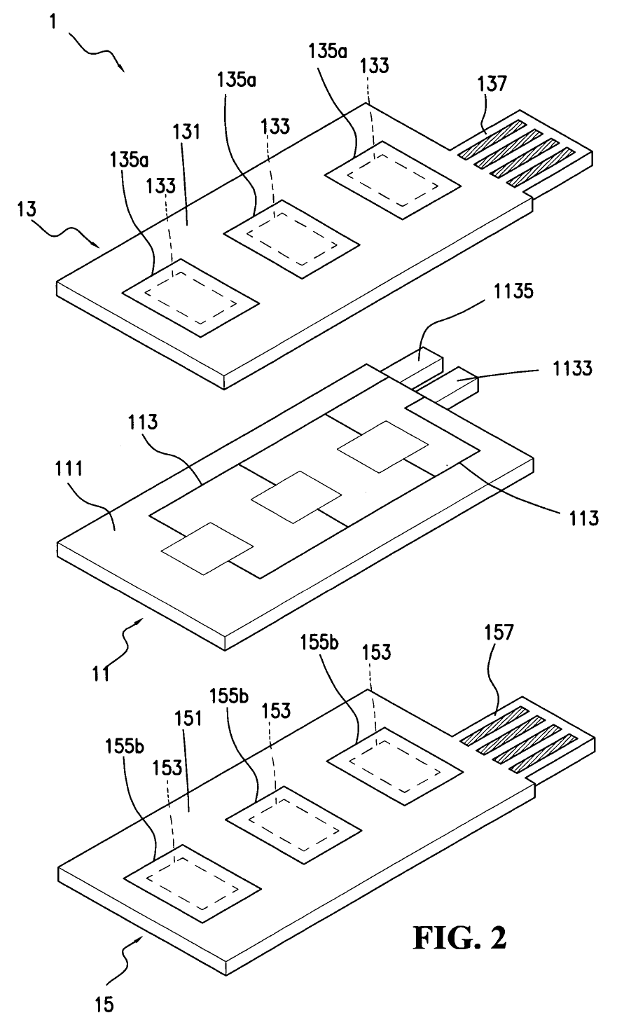

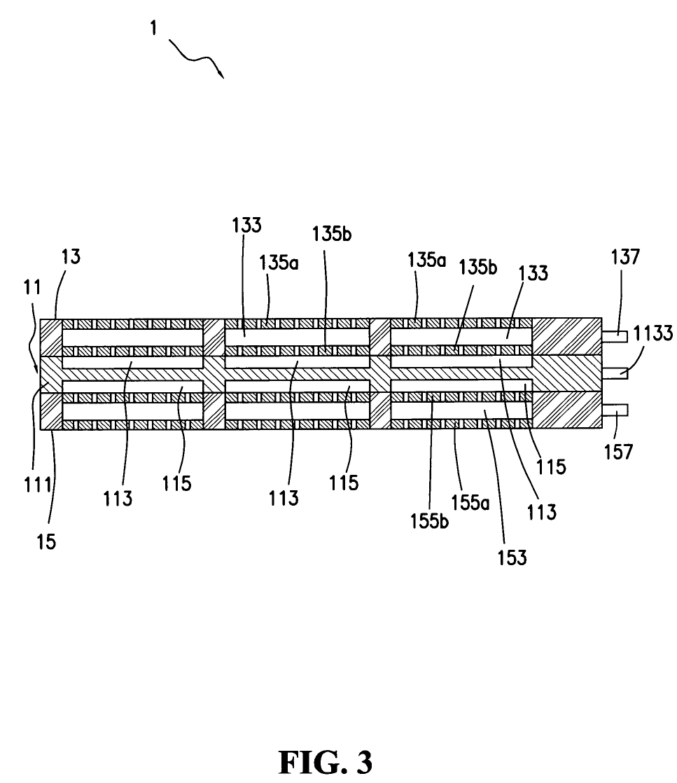

FIG. 1 shows the elevational view of the fuel cell apparatus with double-sided flow field board of the present invention, FIG. 2 shows the decomposition figure of the FIG. 1 of the present invention and FIG. 3 shows the sided cross sectional figure of the FIG. 1 of the present invention. The present invention fuel cell apparatus 1 mainly comprises a double-sided flow field board 11 and two fuel cell boards 13, 15, wherein the fuel cell board 13, 15 are respectively covered and pasted on both sides of the double-sided flow field board 11. Since the fuel cell board 13, 15 are closely touched with the double-sided flow field board 11, the fuel located at the double-sided flow field board 11 does not leak outside, meanwhile, the fuel located at the double-sided flow field board is capable of flowing into the interior of the fuel cell boards 13, 15 to make the fuel cell boards 13, 15 respectively have an electrochemical reaction to produce electrical power.

The fuel cell boards 13, 15 use the same structure, it mainly includes: the substrates 131, 151; plural membrane electrode assemblies 133, 153 which are placed on the local regions of the substrates 131, 151; plural current collection layers 135a, 135b, 155a, 155b which are respectively formed on the top and bottom surfaces of the substrates 131, 151. It also places plural holes within the area of each current collection layer 135a, 135b, 155a, 155b to make the fuel flow to the membrane electrode assemblies 133, 153.

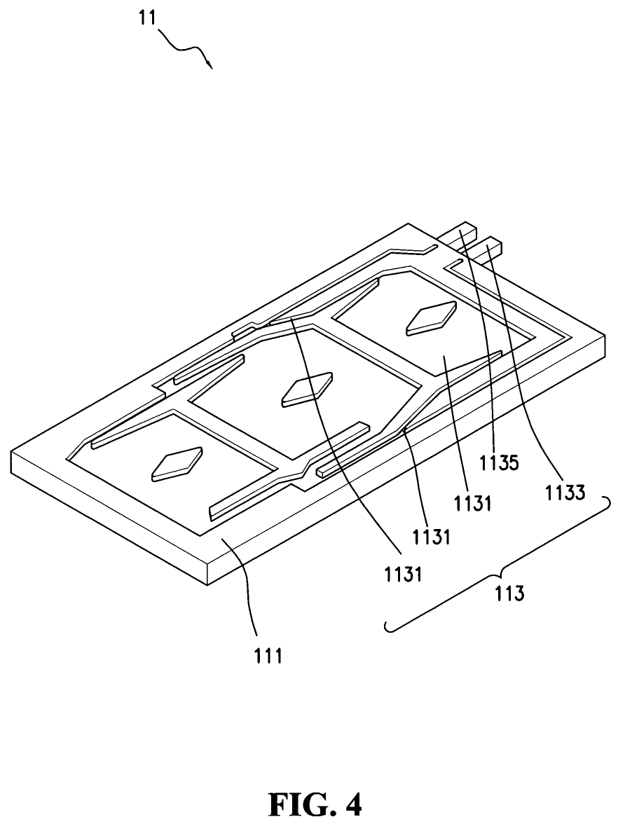

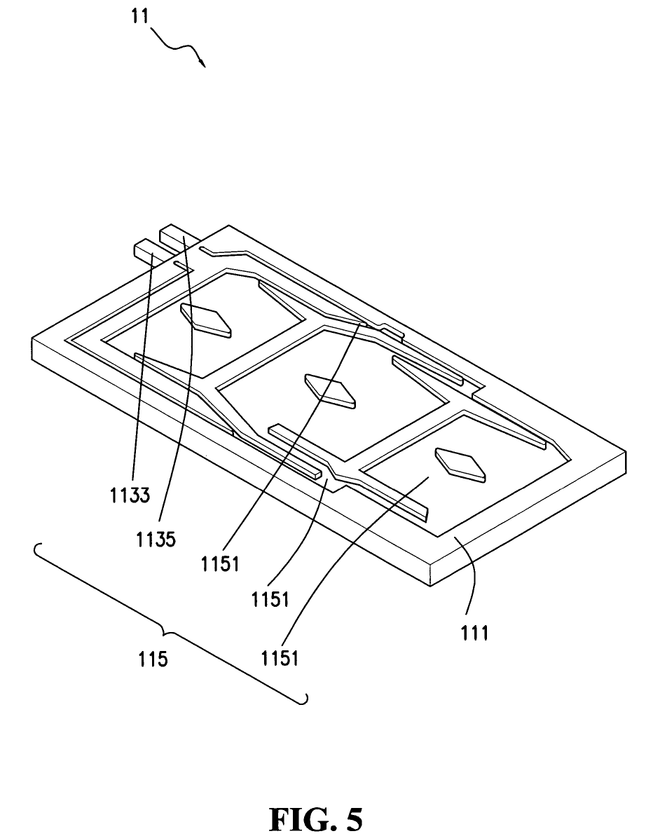

FIG. 4 shows the top view of the top side of the present invention's double-sided flow field board and FIG. 5 shows the bottom view of the bottom side of the double-sided flow field board in FIG. 4. Referring to FIG. 4 and FIG. 5, the substrate of the double-sided flow field board 11 is a plate of board body 111 which is possibly to be the metal, the plastic and respectively forms flow field structure 113, 115 on both top and bottom sides, the main function of flow field structure 113, 115 is to provide fuel flowing to make the fuel successfully flow to the membrane electrode assemblies 133, 153. Furthermore, the flow field structure 113, 115 also provides the channel to exhaust the product produced by the electrochemical reaction of the membrane electrode assemblies 133, 153. The flow field structure 113, 115 generally use the same structure, of course, the example shown in FIG. 4 and FIG. 5 of the flow field structure 113, 115 is purposed to disclose the interpretation so as not to limit the structure. The flow field structure 113, 115 possess the flow field 1131, 1151 and the fuel inlet 1133 which respectively contacts with the flow field 1131, 1151. Furthermore, the flow field structure 113, 115 also possess the fuel exhaust outlet 1135 which respectively contacts with the flow field 1131, 1151.

During assembling the present invented fuel cell apparatus 1, the top and bottom fuel cell boards 13, 15 are respectively squeezed the double-sided flow field board 11 and closely touched on the outer sides of the double-sided flow field board 11. While in use of the present invented fuel cell apparatus 1, external fuels are able to input from the fuel inlet 1133 and then the fuel respectively flows into the flow field 1131, 1151 and finally respectively flows into the interior of the fuel cell board 13, 15. The products after electrochemical reaction of the fuel cell boards 13, 15 respectively flow into the flow field 1131, 1151 and finally flow into the fuel exhaust outlet 1135 to be drained out. The top and bottom fuel cell boards 13, 15 respectively produce the current and electrically connect the supplied voltage to the signal ports 137, 157 for the power supply to the outside by way of the electrical connection in series or in parallel formed by the current collection layers 135a, 135b, 155a, and 155b of the fuel cell boards 13, 15.

Based on the fuel type, the present invented fuel cell apparatus 1 is classified into the fuel cell apparatus of using methanol fuel, the fuel apparatus of using liquid fuel and the fuel cell apparatus of using gas fuel.

The present invented fuel cell apparatus with double-sided flow field board has the following advantages and improvements:

1. Since the top and bottom sides of the double-sided flow field board provide the fuel respectively to the top and bottom fuel cell boards, it makes the present invented fuel cell apparatus possibly miniaturized and also multiplies the electrical power; and

2. Since the present invention fuel cell apparatus with double-sided flow field board uses sheet structure, it makes the present invention possess the advantage of modulization.

Although the present invention has been disclosed one embodiment as the above, it does not imply to limit the present invention, any person who is skilled in the art could make any change or modification within the spirit and scope of the present invention, however, it belongs to the scope of the present invention, the protective scope of the present invention is defined by the following claims.

What is claimed is:

1. A fuel cell apparatus with double-sided flow field board, comprising:
a double-sided flow field board, which includes a board body and the flow field structure respectively placed on both sides of the board body;
two fuel cell boards, which are respectively covered and pasted on both sides of the board body;

2. The fuel cell apparatus with double-sided flow field board according to claim 1, wherein the flow field structure comprises:
a flow field, which contacts the fuel with the interior of the fuel cell board;
a fuel inlet, which is placed on one side of the board body and contacts with the terminal of the flow field.

3. The fuel cell apparatus with double-sided flow field board according to claim 2, wherein the flow field structure further comprises a fuel exhaust outlet which is placed on one side of the board body and conducts with the other side of the flow field.

4. The fuel cell apparatus with double-sided flow field board according to claim 1, wherein the fuel cell board is methanol fuel cell board.

5. The fuel cell apparatus with double-sided flow field board according to claim 1, wherein the fuel cell board is a liquid fuel cell board.

6. The fuel cell apparatus with double-sided flow field board according to claim 1, wherein the fuel cell board is a gas fuel cell board.
